(19) United States
(12) Patent Application Publication
(10) Pub. No.: US 2004/0144927 A1
(43) Pub. Date: Jul. 29, 2004

(54) Microsystems arrays for digital radiation imaging and signal processing and method for making microsystem arrays

(76) Inventors: Gregory W. Auner, Livonia, MI (US); Peter Littrup, Bloomfield Hills, MI (US); Feng Zhong, Windsor (CA)

Correspondence Address: KENYON & KENYON, ONE BROADWAY, NEW YORK, NY, 10004, US

(21) Appl. No.: 10/353,755

(22) Filed: Jan. 28, 2003

(51) Int. Cl. G01T 1/24

(52) U.S. Cl. 250/370.11; 250/370.13; 250/370.09; 118/730

(57) ABSTRACT

An imaging system having at least one microsystem array that is made using a wide bandgap semiconductor and configured in a pixel arrangement. The imaging system also including an electronic readout arrangement integrated with the at least one microsystem array.

### RELATED APPLICATION INFORMATION

This application claims the benefit of and priority to co-pending U.S. patent application Ser. No. 10/125,031, entitled “Apparatus, Method and System for Acoustic Wave Sensors Based on AlN Thin Films”, filed Apr. 17, 2002, the disclosure of which is incorporated by reference in its entirety herein.

### FIELD OF THE INVENTION

The present invention concerns a microsystem array apparatus and system for providing highly sensitive, high resolution radiation imaging for use in digital mammography, computed tomography (CT) detectors, and nuclear medicine cameras, and further concerns a method for making such microsystem arrays.

### BACKGROUND INFORMATION

It is believed that improved radiation and X-ray detector systems for digital imaging and medical diagnosis are needed to reduce radiation exposure, as well as to markedly improve resolution in such application. While X-ray detector systems, such as, for example, standard radiography, fluoroscopy, and computed tomography (CT), may provide high resolution anatomic images, it is believed that they remain governed by the resolution “principle” of “ALARA” (As Low As Reasonably Attainable). Radiation exposure may therefore be a primary concern to the patient, as well as to the system operators attempting to provide adequate image resolution with the lowest possible radiation dosage. In contrast, nuclear medicine may use a comparatively low radiation dosage so that the primary diagnostic problem may become attaining adequate resolution from low count rates. Thus, available radiography, fluoroscopy, and computed tomography (CT) methods and/or systems may benefit by reducing the radiation exposure while nuclear medicine may benefit from improved resolution.

It is believed that the development of screens for plain film radiology has allowed efficient conversion of X-ray energies into light for exposing an underlying exposure film or a bank of digital detectors. Mild decreases in digital image resolution compared to film/screen may be compensated for by improved image contrast to allow comparable medial diagnostic performance for an anatomic region or process. In this regard, it is believed that digital images may provide several potential advantages over standard film use. These may include the following advantages: electronic storage and transfer; image manipulation to correct for under- or over-exposure without additional films; and a large dynamic range that may offer better visualization of “very high” or “very low” density areas without additional exposures.

It is also believed that digital mammography has resulted in a new standard for anatomic detection that balances the effect of noise and contrast, which may sometimes be referred to as “detective quantum efficiency” (DQE). A higher detective quantum efficiency (DQE) should correlate to enhanced detection for even low contrast objects, even though it may have a resolution that is slightly less than available film/screen combinations.

It is also believed that advances in multi-slice scanning have improved the clinical performance of computed tomography (CT) detectors by allowing greater volumes of tissue to be scanned within a similar time period and/or by scanning similar anatomical ranges (such as, for example, chest, abdomen, pelvis) to be scanned at greatly reduced scan times. The matrix detectors used in multi-slice scanning are believed to differ from the older single-slice detector, since they use multiple rows of detectors within each channel. For example, a matrix detector may have 16 rows within 912 channels (that is 14,592 individual elements, where each element is 1 mm by 1.25 mm) as compared with available single-slice detectors that may have 844 channels (where each includes a single 20 mm wide element). Further advances in computed tomography (CT) may therefore depend upon producing greater densities of detectors. In addition, more efficient detectors may decrease the radiation exposure encountered during computed tomography (CT) guided procedures, so that a new era for lung cancer screening, for example, may be possible with rapid, efficient detectors, which may foster further acceptance and study of low-dose, chest computed tomography (CT) screening.

Nuclear medicine involves injecting a low-dose radio-pharmaceutical into a patient, and measuring the intensity distribution of gamma radiation emitted by the patient's body. In particular, the radiation pattern is a measure of blood flow metabolism or receptor density within an anatomic region, and may be useful in providing diagnostic information about organ function. Either a single projection image of the radiation pattern (planar imaging) or multiple projection images may be acquired from different directions to compute a 3-dimensional emission distribution (such as, for example, single photon emission computed tomography or SPECT). Such radiation imaging systems (which may be referred to as “gamma” or “Anger” cameras) may use a large sodium iodide scintillation crystal in conjunction with a bank (such as, for example, 60 to 100) of photo-multiplier tubes (PMT) to convert the crystal scintillations into electrical signals. Limitations of such “gamma” and “Anger” cameras may result from the process of converting scintillations into electrical signals, as well as any limited resolution because of relatively low numbers of photo-multiplier tubes (PMTs) per unit area. It is believed that breast scintigraphy, for example, may be useful in characterizing breast masses and further work is emerging that involves using dual energy detection in combination with digital mammography.

Semiconductor detector-ray imagers have been proposed for use in nuclear medicine because of their relatively small size, light weight, spatial resolution, ability to directly convert gamma photons into electrical signals, on-board signal processing capabilities, and stability and reliability characteristics. Using such detector-ray imagers, gamma-ray radiation may be absorbed into a semiconductor detector producing holes and electrons within the detector material. A bias voltage causes the electrons to separate and move toward opposite surfaces of the semiconductor material in accordance with their respective electrical charge polarities. The electron and hole currents may then be amplified and conditioned by electronic circuitry to produce electrical signals that may be processed to indicate the location and intensity of the corresponding incident gamma-ray radiation. It is understood that prototype semiconductor detection-ray cameras may have been built which have met with varying degrees of success. In this regard, mercury iodide (HgI₂) detectors, for example, may be limited by the need for cryogenic cooling.

The size of the pixels used in a nuclear medicine imaging system is based upon a relatively complex optimization process that may reflect a series of trade-offs. Some factors may be individually optimized if the pixel size is very small. In this regard, for example, such individually optimized factors may include spatial resolution, photodiode dark current, and scintillator light transmission. Additionally, other factors may be optimized using larger pixels, such as, for example, electronics packing density and pixel-to-pixel gamma-ray scattering. It is believed that the actual pixel size (which may be on the order of 3 mm×3 mm) represents a trade-off among these and other factors to provide the “best” overall detector for a nuclear medicine camera. It is believed that subcomponent bonding of cadmium/zinc/telluride-based (CZT) semiconductors may limit individual detectors to approximately 3 mm×3 mm as arranged in an 8×8 detector array. To reduce the surface leakage current between detection elements, the cadmium/zinc/telluride-based (CZT) semiconductor may be subjected to “passivation”, which involves depositing a highly resistive oxide film on the surface of the cadmium/zinc/telluride-based (CZT) semiconductor substrate. Available nuclear medicine cameras using the cadmium/zinc/telluride (CZT) arrangement may tend to report slightly improved resolution over standard Anger cameras, but provide a light-weight portable unit that may more easily obtain images of more localized body parts. The sensitivity of cadmium/zinc/telluride-based (CZT) semiconductors for use in converting gamma rays into electron signals may be relatively limited, and the circuitry bonding configuration may provide relatively minor increases in effective resolution.

In view of the above cited considerations and deficiencies of the existing and/or proposed systems, it is believed that development of new materials in the areas of biomaterials/organics and electro-ceramics may be required, as well as new chemical and plasma etching methods and precise micro-machining technology.

### SUMMARY OF THE INVENTION

The exemplary embodiments and/or methods of the present invention concern using high temperature, broad bandwidth semiconductor materials with “exquisite” sensitivity manufactured in minute configurations to solve the problems that may be associated with X-ray and other radiation detectors. Such semiconductor materials may include, for example, silicon carbide (SiC), II-V nitrides such AlN and GaN, and their heterostructures. The wide band-gap semiconductor based radiation detection devices may provide a superior low dark current (noise) at room temperature during operation, a high radiation resistance when exposed to high radiation levels, and a high breakdown voltage and thermal conductivity of the material thereby allowing the application of high voltages.

The exemplary embodiments and/or methods of the present invention may use an ultra high vacuum (UHV) deposition technique to deposit and characterize the wide band-gap semiconductor material into epitaxial thin films, which may then be micro-machined into high-density pixelated structures and assembled to form a microsystem array system that may be used for radiation detection. The epitaxial thin films may act as a photoconducting medium when exposed to, for example, X-rays. In particular, the incident X-ray photons may create electron-hole pairs resulting in a current flow under electric field conditions, wherein the signal-to-noise ratio between the dark current and the photocurrent at a high X-ray energy regime may be on the order of about 20:1. As such, the wide band-gap semiconductor in an epitaxial thin film form may provide a superior detection material as compared with traditionally-used materials.

The exemplary embodiments and/or exemplary methods of the present invention involve making or providing microsystem arrays of a wide bandgap aluminum nitride (AlN) semiconductor configured in a high density pixel arrangement with integrated electronics for use in providing highly sensitive, high-resolution imaging. The microsystem arrays may be modular (such as, for example, 1 cm by 1 cm) so that they may be linked with other modules to form a larger area, high density system. The exemplary embodiments and/or exemplary methods may also involve using an optional scintillating layer for use in higher energy regimes and/or a microprocessor for coordinating and displaying the imaging information. It is believed such advanced microsystem arrays having the unique, new broad bandwidth and/or wide bandgap aluminum nitride (AlN) semiconductor may markedly reduce exposure in X-ray and radiation detection applications, while offering a significant increase (such as, for example, a 10-fold increase) in detection sensitivity and inherent resolution.

The exemplary embodiments and/or exemplary methods of the present invention also involve using a deposition method of plasma source molecular beam epitaxy (PSMBE) to prepare the wide bandgap aluminum nitride (AlN) semiconductors at low temperatures. The plasma source molecular beam epitaxy (PSMBE) deposition method may include the use of a magnetically enhanced hollow cathode deposition source for growing the wide bandgap aluminum nitride (AlN) semiconductors.

The exemplary embodiments and/or exemplary methods of the present invention also involve using an excited dimmer (Excimer) laser micro-machining arrangement or setup to produce the microsystem arrays, as well as a smart sensor system that hybrids the smart sensor device with processing electronics into one system for use in providing efficient control and communication features.

Another exemplary embodiment and/or exemplary method is directed to providing an imaging system including at least one microsystem array, the at least one microsystem array composed of a wide bandgap semiconductor and being in a pixel arrangement; and an electronic readout arrangement integrated with the at least one microsystem array.

Yet another exemplary embodiment and/or exemplary method of the present invention is directed to providing the microsystem array imaging system, in which the wide bandgap semiconductor includes one of a metal and an electrically conductive material.

Still another exemplary embodiment and/or exemplary method of the present invention is directed to providing the microsystem array imaging system, in which the wide bandgap semiconductor includes aluminum nitride.

Yet another exemplary embodiment and/or exemplary method of the present invention is directed to providing the microsystem array imaging system, in which the wide bandgap semiconductor includes silicon carbide.

Still another exemplary embodiment and/or exemplary method of the present invention is directed to providing the microsystem array imaging system, in which the at least one microsystem array includes a high density pixel arrangement.

Yet another exemplary embodiment and/or exemplary method of the present invention is directed to providing the microsystem array imaging system, in which the at least one microsystem array has at least 2500 pixels per square centimeter.

Still another exemplary embodiment and/or exemplary method of the present invention is directed to providing the microsystem array imaging system, including a scintillating layer associated with the at least one microsystem array.

Yet another exemplary embodiment and/or exemplary method of the present invention is directed to providing the microsystem array imaging system, in which the scintillating layer is composed of quartz crystals.

Still another exemplary embodiment and/or exemplary method of the present invention is directed to providing the microsystem array imaging system, in which the scintillating layer is composed of cadmium/zinc/telluride (CZT) crystals.

Yet another exemplary embodiment and/or exemplary method of the present invention is directed to providing the microsystem array imaging system, including a processor arrangement coupled to the electronic readout arrangement.

Still another exemplary embodiment and/or exemplary method of the present invention is directed to providing the microsystem array imaging system, in which the at least one microsystem array is arranged as a module.

Yet another exemplary embodiment and/or exemplary method of the present invention is directed to providing the microsystem array imaging system, in which the at least one microsystem array is micro-machined by an Excimer laser.

Yet another exemplary embodiment and/or exemplary method of the present invention is directed to providing the microsystem array imaging system, in which the wide bandgap semiconductor is formed by plasma source molecular beam epitaxy.

Still another exemplary embodiment and/or exemplary method of the present invention is directed to providing a deposition system for forming a wide bandgap semiconductor, the deposition system including a plasma source molecular beam epitaxy (PSMBE) deposition source, a high vacuum chamber, and a rotating substrate holder enclosed in the high vacuum chamber, in which the plasma source molecular beam epitaxy (PSMBE) deposition source is configured to induce crystal growth to form the wide bandgap semiconductor on a substrate positioned on the rotating substrate holder.

Yet another exemplary embodiment and/or exemplary method of the present invention is directed to providing a deposition system for forming wide bandgap semiconductors, in which the substrate holder is heated to between 650° C. and 800° C.

Yet another exemplary embodiment and/or exemplary method of the present invention is directed to providing the deposition system for forming wide bandgap semiconductors, in which the deposition source includes a magnetically enhanced hollow cathode to induce plasma formation.

Still another exemplary embodiment and/or exemplary method of the present invention is directed to providing the deposition system for forming wide bandgap semiconductors, in which the crystal growth includes polycrystalline crystals.

Yet another exemplary embodiment and/or exemplary method of the present invention is directed to providing the deposition system for forming wide bandgap semiconductors, in which the crystal growth includes single crystals.

Still another exemplary embodiment and/or exemplary method of the present invention is directed to providing the deposition system for forming wide bandgap semiconductors, in which the crystal growth includes hexagonal structures.

Yet another exemplary embodiment and/or exemplary method of the present invention is directed to providing the deposition system for forming wide bandgap semiconductors, in which the crystal growth includes an initial compliant layer formed at a low temperature.

Still another exemplary embodiment and/or exemplary method of the present invention is directed to providing the deposition system for forming wide bandgap semiconductors, in which the substrate is sapphire.

Yet another exemplary embodiment and/or exemplary method of the present invention is directed to providing the deposition system for forming wide bandgap semiconductors, in which the wide bandgap semiconductor is composed of aluminum nitride (AlN).

Still another exemplary embodiment and/or exemplary method of the present invention is directed to providing a microsystem array smart sensor, including a microsystem array sensor arrangement to emit a signal, an amplifier arrangement to amplify an emitted signal, a hardware processing arrangement to process an amplified signal, a data converter to covert a processed signal to provide a converted signal for transmission, and a data bus to transmit the converted signal, wherein the microsystem array sensor arrangement is made of a wide bandgap semiconductor.

Yet another exemplary embodiment and/or exemplary method of the present invention is directed to providing the microsystem array smart sensor in which the wide bandgap semiconductor includes aluminum nitride.

Yet another exemplary embodiment and/or exemplary method of the present invention is directed to providing the microsystem array smart sensor, including a data communication arrangement interfaced with the data bus.

Still another exemplary embodiment and/or exemplary method of the present invention is directed to providing the microsystem array smart sensor, including a software process arrangement interfaced with the data communication arrangement.

Yet another exemplary embodiment and/or exemplary method of the present invention is directed to providing the microsystem array smart sensor, in which signals of the microsystem array sensor arrangement are communicated to a centralized processor arrangement.

Still another exemplary embodiment and/or exemplary method of the present invention is directed to providing a microsystem array smart sensor system, including a plurality of microsystem array sensor arrangements made using a wide bandgap semiconductor and at least one combining node, in which the plurality of microsystem array sensor arrangements and the at least one combining node are arranged in a hierarchical structure.

Yet another exemplary embodiment and/or exemplary method of the present invention is directed to providing a microsystem array smart sensor system, in which the wide bandgap semiconductor includes aluminum nitride.

### BRIEF DESCRIPTION OF THE DRAWINGS

FIG. 1A shows an exemplary embodiment of a wide bandgap aluminum nitride (AlN) semiconductor microsystem array imaging system.

FIG. 1B shows a breakdown voltage comparison between various wide bandgap semiconductor materials and a silicon-based material.

FIG. 1C shows a thermal conductivity comparison between various wide bandgap semiconductor materials and a silicon-based material.

FIG. 2 shows an exemplary embodiment of a plasma source molecular beam epitaxy (PSMBE) system.

FIG. 3A shows an exemplary embodiment of a magnetically enhanced hollow cathode deposition system arrangement.

FIG. 3B shows a high resolution transmission electron micrograph (TEM) of a single crystal aluminum nitride (AlN) thin film grown on a sapphire substrate using the magnetically enhanced hollow cathode deposition system arrangement of FIG. 3A.

FIG. 3C shows a scanning electron microscopy (SEM) image in cross-sectional view of a single crystal aluminum nitride (AlN) thin film grown on a sapphire substrate using the magnetically enhanced hollow cathode deposition system arrangement of FIG. 3A.

FIG. 3D shows a reflection high energy electron diffraction (RHEED) pattern of a single crystal aluminum nitride (AlN) thin film grown on a sapphire substrate using the magnetically enhanced hollow cathode deposition system arrangement of FIG. 3A.

FIG. 3E shows an X-ray diffraction (XRD) spectra for a single crystal aluminum nitride (AlN) thin film grown on a sapphire substrate using the magnetically enhanced hollow cathode deposition system arrangement of FIG. 3A.

FIG. 3F shows an X-ray photon response for a single crystal aluminum nitride (AlN) thin film grown on a sapphire substrate using the magnetically enhanced hollow cathode deposition system arrangement of FIG. 3A.

FIG. 4 shows an exemplary embodiment of an Excimer laser micro-machining arrangement according to the present invention.

FIG. 5 shows an exemplary embodiment of a solid state digital radiation detector system.

FIG. 6 shows an exemplary scanned-slot detector arrangement.

FIG. 7 shows an exemplary embodiment of a microsystem array smart sensor arrangement.

### DETAILED DESCRIPTION

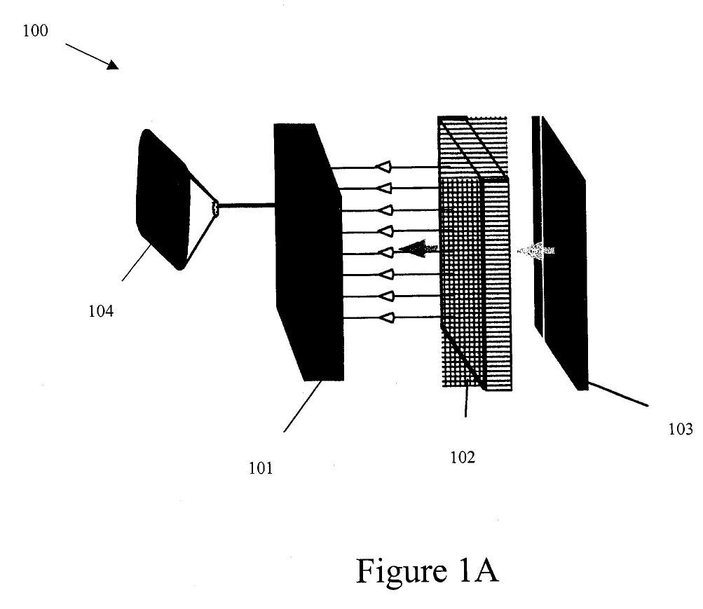

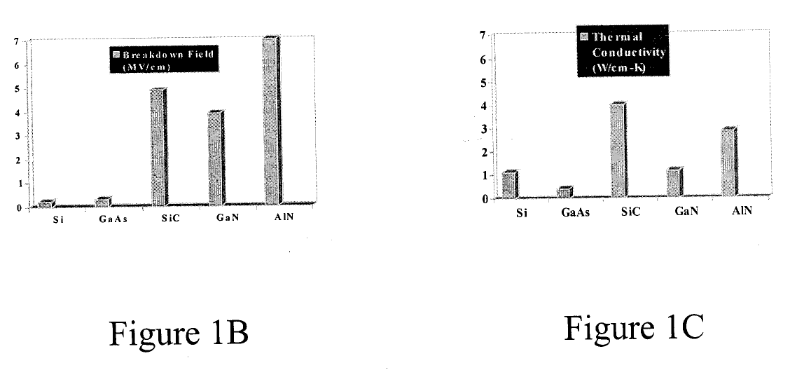

FIG. 1A shows a wide bandgap aluminum nitride (AlN) semiconductor microsystem array imaging system 100. The imaging system 100 includes an aluminum nitride (AlN) wide bandgap pixelated detection array 102, which is integrated with a high density (such as, for example 128×128 pixels), low noise (such as, for example, at least a 20:1 signal ratio), high gain electronic readout circuitry 101 for use in reading out the imaging data. The imaging system 100 may also include an optional scintillating layer 103 for use in higher energy regimes (such as, for example, an energy regime of about 0.5 Mev) and/or a microprocessor 104 for coordinating and displaying the imaging information. A modular arrangement of the microsystem array imaging system 100 (which may be, for example, 1 cm by 1 cm) may be linked with other such microsystem array modules to form a larger area, high density imaging system.

In the imaging system 100, photon energy (such as, for example, 35 KeV) is applied so that incident photons create electron-hole pairs resulting in a current flow under electric field conditions. The aluminum nitride (AlN) wide bandgap semiconductors have “nearly” zero dark current at temperatures up to several hundred degrees Celsius, which eliminates the need for a pn junction. Furthermore, the high breakdown voltage and the thermal conductivity of the wide bandgap aluminum nitride (AlN) semiconductor material (which may be on the order of 7 MV/cm and 3 W/cm-K respectively) allow the application of high voltages.

FIGS. 1B and 1C show the relative thermal conductivity and breakdown comparisons between various wide band-gap semiconductor materials and a silicon-based material. As demonstrated by the Figures, silicon carbide (SiC) and aluminum nitride (AlN) provide a significantly higher breakdown voltage and thermal conductivity as compared with silicon (Si).

The high field effect of the wide bandgap aluminum nitride (AlN) semiconductor is believed to provide especially high photon detecting sensitivity and rapid response. In particular, the signal-to-noise ratio between the dark current under extremely low photon count conditions may exceed on the order of about 100:1, for example. Furthermore, the current measurement may remain constant over a broad temperature range (such as, for example, well above 200° C.). Since available silicon-based pn junction photodiodes may require cooling during operation and may have a lower breakdown threshold, it is believed that the wide bandgap aluminum nitride (AlN) semiconductor material may offer various advantages. In particular, with silicon-based materials the active area in the pn junction and the thermal sink to the cooling unit may require additional space that limits the pixel size of the silicon-based pn junction photodiode. Thus, for example, the pixel size of such silicon-based pn junction photodiodes may be only slightly less than 1 mm in diameter. Such a limited pixel size may limit the ultimate resolution of an imaging system. Furthermore, the need for cooling and/or the lack of a perfect thermal heat sink may also increase the signal-to-noise ratio so as to limit the ultimate detectability threshold in the imaging system. In contrast, the microsystem array made using the wide bandgap aluminum nitride (AlN) semiconductor may be made 100 μm in diameter or smaller, and is believed to possess a high field capability so as to allow for improved detectability.

For higher energy regimes, a scintillating layer 103 (which may be, for example, quartz or cadmium/zinc/telluride (CZT)) is shown in front of the aluminum nitride (AlN) pixelated detection array 102. In this arrangement, the high energy radiation illuminates the scintillating layer 103 and the aluminum nitride (AlN) pixelated detection array 102 detects the resulting photon emissions. The scintillating layer 103 may be micro-machined using an array of micro-lenses to concentrate the illuminating light onto the underlying sensing medium. If cadmium/zinc/telluride (CZT) is used, it may provide good energy and spatial resolution, operate at room temperatures, and may be manufactured in a variety of dimensions.

Uniquely, the advanced microsystem array 100 uses the broad band-width, wide bandgap aluminum nitride (AlN) semiconductor to reduce markedly or at least reduce exposure in X-ray and radiation detection applications, while offering a significant increase (such as, for example, a 10-fold increase) in detection sensitivity and inherent resolution. The reduced radiation, improved photon sensitivity, and improved spatial resolution should significantly expand diagnostic capabilities in multiple sub-specialties. For example, such advanced microsystem arrays applied in digital mammography may be used to improve the absolute spatial resolution abilities, while markedly decreasing exposure. In particular, it is believed that fluoroscopic assessment may be improved, as well as biopsy accuracy. Furthermore, improved cancer detection may also be expected, since it is believed that available digital mammography relies on enhanced tissue contrast to make up for somewhat degraded resolution as compared with traditional film screen mammography.

The advanced microsystem array 100 when used in computed tomography (CT) may also be used to improve the absolute spatial resolution to provide improved contrast agent assessment, tissue contrast, and hardware longevity (such as, for example, tube burnout). The much lower radiation exposure may also rejuvenate interest in computed tomography (CT) fluoroscopy, which has previously been considered to be limited by its relatively high exposure levels. Furthermore, when applied in nuclear medicine cameras, the wide bandgap semiconductor array 100 may used to replace the limited ratio of one (1) sodium iodide crystal (in 60 to 100 photo-multiplier tube systems). It is believed that this should enable markedly improved spatial resolution as well as reduced radiation exposure and enhanced sensitivity.

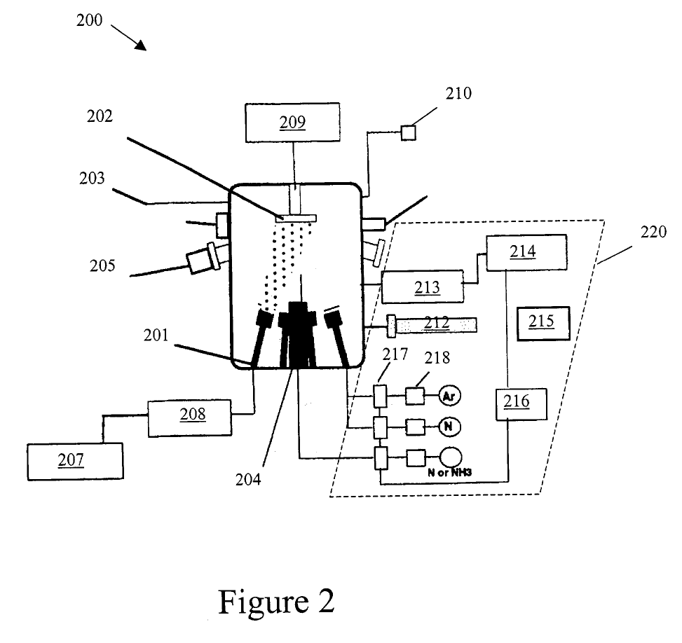

Uniquely, the wide bandgap aluminum nitride (AlN) semiconductor microsystem array 100 may be prepared using the new deposition technique of plasma source molecular beam epitaxy (PSMBE). It is believed that the plasma source molecular beam epitaxy (PSMBE) system 200 of FIG. 2 provides the capability of depositing the exemplary wide bandgap semiconductor microsystem arrays at lower temperatures than may be accomplished using other methods, such as, for example, plasma enhanced chemical vapor deposition. Growth temperatures (as low as 350° C., for example) allow direct integration with silicon-based integrated circuits. Developing an initial compliant layer (such as, for example, 200-500 Angstroms) at a low temperature (such as, for example 200° C.) upon the initiation of growth of the microsystem array on the substrate is intended to provide relatively strain-free wide bandgap semiconductor crystals, which should facilitate the removal of the aluminum nitride (AlN) crystals from the underlying substrate when needed. Alloying aluminum nitride (AlN) with other wide bandgap semiconductors may also be done to provide a greater spectral range of light detection, and add versatility to selecting of the available scintillating layers. Thus, the detecting medium may be customized for use over a broad spectral range.

FIG. 2 shows an exemplary embodiment of a plasma source molecular beam epitaxy (PSMBE) system. The plasma source molecular beam epitaxy (PSMBE) system 200 includes a plasma source molecular beam epitaxy (PSMBE) source 201 and a rotating heated substrate holder 202 (heated to between 650° C. and 800° C. for example) enclosed in an ultra high vacuum (UHV) chamber 203 with a high base pressure. For example, the high base pressure may be in the upper 10⁻¹¹ Torr region. Wafers (which maybe up to three inches for example) may be loaded on the rotating heated substrate holder 202. The plasma source molecular beam epitaxy (PSMBE) system 200 may also include in-situ analytical systems, such as an infrared pyrometer 204 for measuring substrate temperatures, an optical spectrometer 205 for analyzing the plasma, and a 35 kV reflective high-energy electron diffraction (RHEED) system 206 for analyzing film. Such analytical systems may operate in real time to provide added versatility in controling wide bandgap semiconductor film growth in the plasma source molecular beam epitaxy (PSMBE) system 200.

The plasma source molecular beam epitaxy (PSMBE) system 200 may also include a radio frequency (RF) sputtering power supply 207 with an auto-matching network 208 connected to the plasma source molecular beam epitaxy (PSMBE) source 201, a substrate bias power supply 209 (which may be fed via the rotating substrate holder 202), a capacitance manometer 210, a 30 KeV reflective high-energy electron diffraction (RHEED) gun 211, and a mass flow control system 220. As shown, the mass flow control system 220 includes a cryopump 212, a differential pumping device 213, a residual gas analyzer 214, an ion pump 215, a controller 216, and individual mass flow arrangements 217, as well as gas purifier arrangements 218 for each element (such as, for example, argon (Ar), nitrogen (N), and ammonia (NH₃)).

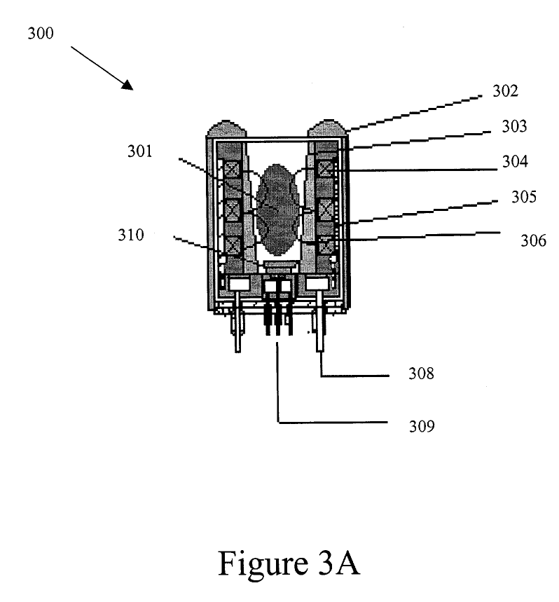

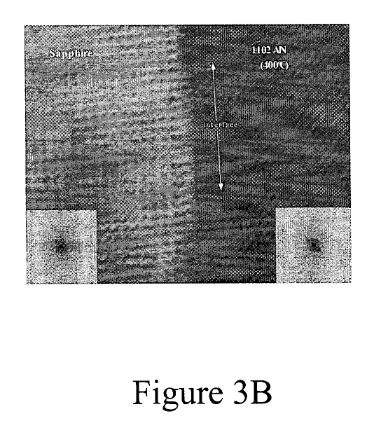

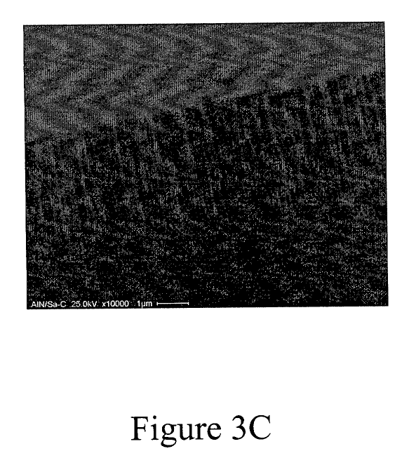

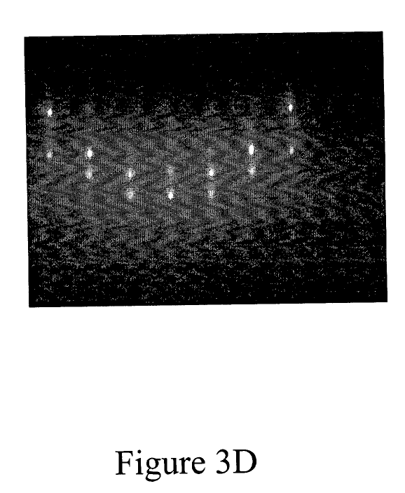

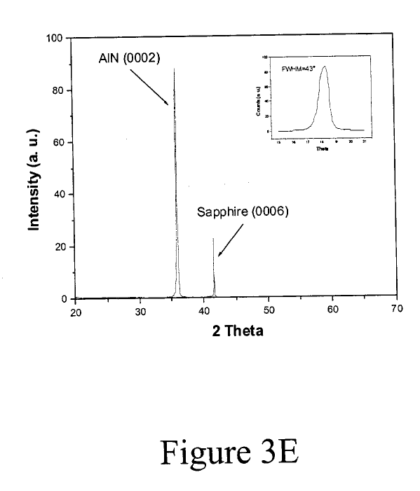

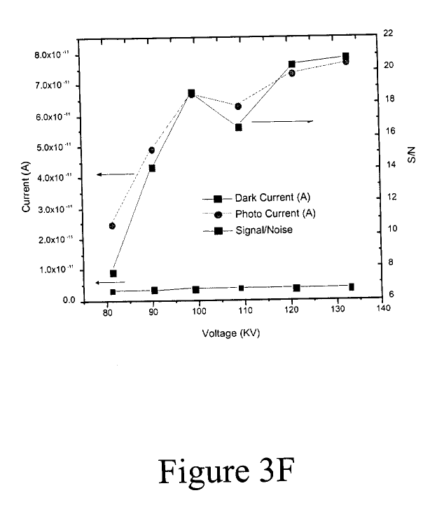

The plasma source molecular beam epitaxy (PSMBE) source 201 may use a magnetically enhanced hollow cathode arrangement, which is lined with the target material. FIG. 3A shows an exemplary embodiment of the magnetically enhanced hollow cathode arrangement 300. A plasma 301 (which may be nitrogen or nitrogen/argon) is formed within the magnetically enhanced hollow cathode 300, which includes impeller 310 to provide an acceleration intake bias via a gas inlet 309. The walls 302 of the magnetically enhanced hollow cathode 300 are lined with a target deposition material 303. This target deposition material 303 may be molecular beam epitaxy (MBE) grade aluminum (Al) or other suitably appropriate deposition material. Magnets 304 and magnetic return 305 are provided to induce a magnetic field 306. A radio frequency (RF) or pulsed dc power 308 is coupled to the magnetically enhanced hollow cathode 300, which is intended to provide an efficient plasma formation due to the hollow cathode effect and the magnetically induced effective pressure increase. The plasma 301 dissociates the diatomic nitrogen molecule into radical ions, as well as other combinations. The ions sputter atoms from a surface of the magnetically enhanced hollow cathode 300 (such as, for example, in a normal direction). Multiple collisions may occur before an aluminum (Al) atom or ion escapes as the nitrogen and aluminum ions are accelerated to an appropriate specific energy. The specific energy for aluminum nitride (AlN) is believed to be 12 eV. The condensing adatoms may therefore have highly regulated energy. Thus, crystal growth may occur even at low substrate temperatures (such as for example, on the order of about 350° C. The aluminum nitride (AlN) crystal growth may be tailored from a polycrystalline structure to near single crystalline structure, which includes both hexagonal and other shaped structures. For example, a single high quality crystal formed using aluminum nitride (AlN) may be grown on a sapphire-based substrate.

FIGS. 3B-F shows the structure and characteristic properties of an exemplary single crystal aluminum nitride (AlN) thin film epitaxially grown on a Sapphire substrate using the PSMBE system 200 of FIG. 2. In particular, FIG. 3B shows high resolution transmission electron micrograph (TEM) of the AlN thin film, FIG. 3C shows a scanning electron microscopy (SEM) picture of the AlN thin film, FIG. 3D shows a reflection high energy electron diffraction (RHEED) pattern of the AlN thin film, FIG. 3E shows an X-ray diffraction (XRD) spectra for the AlN thin film, and FIG. 3F shows the X-ray response for the AlN thin film demonstrating the signal-to-noise ratio with respect to dark current and photocurrent. The aluminum nitride (AlN) films grown on sapphire substrates may be removed to form free standing crystals by irradiating through the sapphire wafer using high energy Excimer laser pulses. The resulting films may then be micro-machined into free standing bridge structures if needed.

Using the magnetically enhanced hollow cathode arrangement 300, the plasma source molecular beam epitaxy (PSMBE) source 201 is arranged to permit wide-ranging parameter control, including parameters such as the flux energy (that is, the energy ranging from thermal to high energy due to an added bias) of the depositing species achieving precise composition control. The ions may be precisely accelerated by the impeller 310 to heat the substrate. Maintaining an energy level that is approximately half that of the deposited crystal displacement energy (that is, the bulk crystal displacement energy, which may be on the order of about 32 eV, for example) is intended to better ensure maximum mobility, bond formation, ejection of contaminants, and crystal growth quality, while at least reducing or eliminating ion induced damage to the growing crystalline structure.

To develop microsystem array structures for use in extending the capabilities of various biomedical microsystems referred to herein, for example, the exemplary embodiments and/or exemplary methods of the present invention involves the use of Excimer laser technology. Excimer lasers operate in the ultra-violet (UV) range and emitt high photon energy (Excimer stands for “excited dimmer”, a diatomic molecule, which may be an inert gas atom and a halide atom, having a very short lifetime and dissociates releasing energy through ultra-violet (UV) photons).

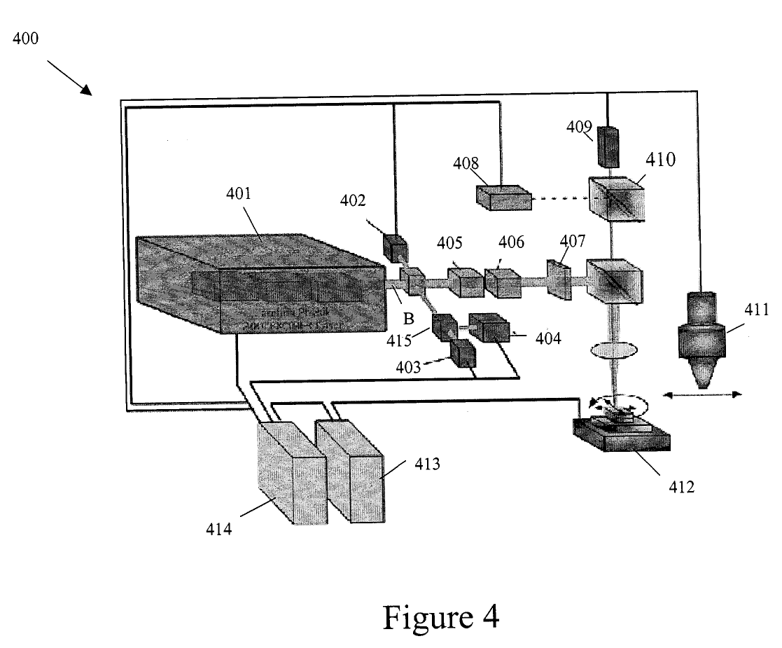

FIG. 4 shows an exemplary embodiment of an Excimer laser micro-machining arrangement 400. As shown, the Excimer laser micro-machining arrangement 400 includes a laser source 401. The laser source 401 may be, for example, a Lambda Physik 200 Excimer laser, which may be operated in a KrF mode so as to emit a wavelength of about 248 nanometers, for example. Operation at this wavelength is intended to provide superior results when compared to operation at smaller emitted wavelengths. The resulting laser beam B may reach an energy level on the order of about 600 mJ, for example, with a pulse duration of 25 nanoseconds and a rectangular output beam having dimensions of about 23 mm×8 mm. The laser beam B passes through a neutralized continuously tunable attenuator arrangement 405 and a homogenizer arrangement 406 having a micro-lens array arrangement. The micro-lens array arrangement of the homogenizer 406 is used to split the laser beam B into different beamlets traveling along different paths, and is also used to overlap them on a plane to be irradiated (that is, the mask 407).

The gaussian beam profile of the laser beam B is then transformed to a near perfect or essentially flat-top shape (which may be a flatness of 0.87, for example). The mask 407 is placed in the homogenized plane (with a homogenized illumination area of 18 mm×18 mm, for example) and imaged by an objective lens onto the sample. The sample is placed on top of an ultra-precision 4-dimensional scanning stage 412 (which may be, for example, a Newport PM500, X, Y, Z and rotation; X and Y with 80 mm travel limit, and 0.05 μm-linear resolution; Z with 25 mm travel limit, and 0.025 μm linear resolution; rotation stage with 360° travel, and 0.00030 rotary resolution). A photon beam profiler 404 is used to measure the laser beam intensity profile, and a pyroelectric energy sensor 402 is used to measure the laser pulse energy, and a fast-response. A photodiode 415 (which may be a Hamamatsu photodiode) is used to measure the pulse time shape. A processor arrangement 414 and motion control system 413 is used to control the Excimer laser micro-machining arrangement 400. This may include control of the laser source 401, sample scanning stage to control micropatterning design and fabrication, and laser beam characterization. The Excimer laser micro-machining arrangement 400 may also include a computer controlled display (CCD) camera 408, an alignment laser arrangement 409, a beam splitter 410, and an optical surface profiler (interferometer) 411.

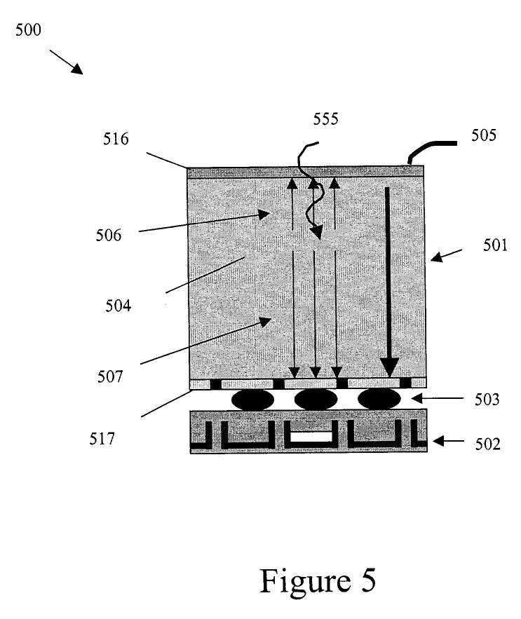

FIG. 5 shows an exemplary embodiment of a solid state digital radiation detector system 500 using wide band-gap materials. The detector system 500 includes a photodiode array layer 501 electrically coupled to a readout layer 502 using indium bump bonds 503 to form one hybrid detector. The photodiode layer is bulk crystal SiC and epitaxial grown AlN thin films. The AlN material may be easily grown on SiC since the lattice mismatch for these two materials is small (within 1%). The photodiode layer may be reversed biased or configured as p-i-n to improve radiation induced charge carrier collection. The lower surface is pixellated to accompany the imaging application.

During operation, the incoming radiation 555 (such as, for example, X-ray or Gamma ray radiation) is absorbed in the photodiode array layer 501 and converted directly into electron-hole pairs. The photodiode array layer 501 may be configured either reverse biased or p-i-n configured, which forms a depletion region 504. Electron-hole pairs are swept apart by the electric field induced by bias 505, so that the electrons 506 are swept to the n-region 516 and the holes 507 are swept to the p-region 517.

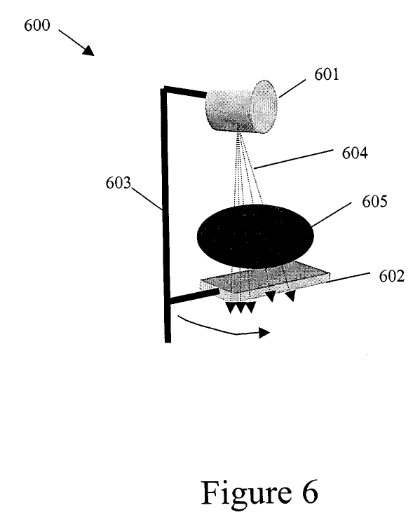

FIG. 6 shows an exemplary scanned-slot detector configuration 600 for scanning a large area. Scanned-slot detector configuration 600 includes an X-ray tube 601 and a slot-like detector array 602 coupled to a swing arm 603. During operation, X-ray beams 604 scan object 605 along scan a direction 606 to be tracked by the slot-like detector array 602. Since only a thin slot is irradiated at one time, the scanned-slot configuration may provide improved scatter reduction, thereby increasing image contrast without the need for an anti-scatter grid. The elimination of the grid may allow for a reduced radiation dose to the patient. To further limit the radiation, the slot-like detector array may be assembled into a curved structure with a radius equal to the X-ray source-to-detector distance. In this manner, radiation entering into adjacent pixels may be minimized.

The scanned-slot detector configuration 600 may involve a readout circuit operating in a time delay integration (TDI) mode. The TDI mode may simplify the mechanical scanning as compared to other prior systems. Furthermore, since each pixel in the imaging may result from the integration of multiple signals, the scanned-slot detection configuration 600 may provide an increased detector yield and/or a reduction in cost.

Implemehting the sensor and/or device of the microsystem array may be done using computer simulation. In particular, the design may be set via a metal oxide semiconductor implementation service (MOSIS) system for use in fabrication, and followed by hybridizing the sensor and integrated circuit in a static secondary ion mass spectroscopy (SSIM) equipment facility. The metal oxide semiconductor service (MOSIS) system may provide low-cost prototyping and small volume production service for custom and semi-custom very large scale integration (VLSI) circuit development. Available semiconductor technologies may include digital complementary metal oxide semiconductor (CMOS), mixed signal CMOS, gallium arsenide-based (GaAs), and multi-chip module (MCM) fabrication in the case of microsystem arrays on silicon-based substrates. Both hybrid chip technology and novel materials structures on a VLSI chip may be used. The VLSI circuitry may be developed and fabricated using metal oxide semiconductor service (MOSIS) with a surface mounting section for sensor chip integration. The retical aluminum nitride (AlN) microsystem array sensor may be flip-chip-bound to the VLSI readout system.

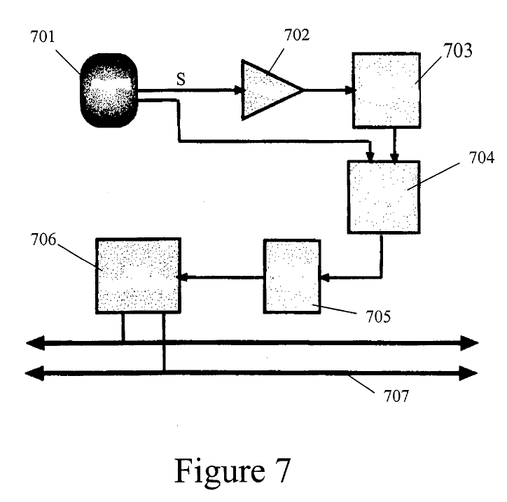

The exemplary embodiments and/or exemplary methods of the present invention may also incorporate an intelligent or smart sensor design that involves hybridizing a sensor device together with processing electronics in one system for providing efficient control and communication. FIG. 7 shows an exemplary embodiment of a microsystem array smart sensor arrangement 700. As shown, a sensor signal S emanates from microsystem array sensor 701, and is amplified via an amplifier 702, pre-processed via hardware processing arrangement 703, and converted for transmission via a data converter arrangement 704 to a data bus arrangement 707. The data bus arrangement 707 may be standardized. Prior to transmitting information on the data bus arrangement 707, a software processor arrangement 705 and a data communication arrangement 706 may be used to assist interface with the data bus arrangement 707. Such a smart sensor arrangement is intended to provide for the consolidation of a multitude of microsystem array sensors along a single data bus to a central processing arrangement.

One problem with combining large numbers of microsystem array sensors is handling the enormous volume of data that may be generated. An exemplary method to address this problem includes having the microsystem array sensors communicate their data to a centralized processor arrangement, which analyzes the messages and processes each of the messages based on the data received. Such an approach, however, may not work with a reasonably large number of microsystem array sensors (for example, on the order of about 128×128 sensors) for the following reasons. First, it may be difficult to couple a large number of microsystem array sensors to a single processor arrangement because the number of data pins may be limited, so as to fall short of the number required. Second, the processor arrangement may not have sufficient processing power to handle the expected incoming traffic that a huge number of microsystem array sensors might provide.

Alternatively, to reduce communication traffic, the microsystem array sensors may be restricted to respond only when they encounter “interesting” data. Otherwise, the sensors should remain non-responsive. This method may be used where one would expect lengthy periods of time when there are no anomalies to report (such as might be found in sensors used to monitor the structural integrity of a bridge, for example). Such an approach may, however, require periodic responses to ensure that the microsystem array sensors and communication links are operable.

Other exemplary approaches may require transmitting data on a more regular basis. In this regard, for example, microsystem array sensors used to detect sub-atomic particles may have frequent events to report. In such a case, suppressing “uninteresting” data may not noticeably reduce the communication traffic. For these situations, a smart processor may be attached to each microsystem array sensor in order to accumulate information and periodically relay it to a centralized processor arrangement. Although the added cost of providing additional capabilities to each microsystem array sensor may be reasonable, such an approach may still be limited by the number of smart processors that may be attached to the central processor arrangement.

Alternatively, a more scalable method involves using a hierarchy of combining nodes. In particular, the combining nodes may be connected in a tree structure, and the leaves of the tree are microsystem array sensors in which some of the microsystem array sensors are connected to a combining node. A number of combining nodes may then be connected to a high-level combining node. Additional iterations of this configuration may be implemented until all data is accumulated at a central node. The collection of combining nodes may then form a network, in which each combining node includes a processor and memory (as needed, depending on the particular application). It is believed that the hierarchical method should allow the required number of combining nodes to be far less or at least less than the number of microsystem array sensors. For example, if the lowest level of the tree contains one combining node for each 10 microsystem array sensors, then there would be nine microsystem array sensors for each of the combining nodes.

Alternatively, a multitude of connection patterns and concentration ratios may be used for different applications, since a single approach may not be sufficient for all types of applications. For example, some applications may involve varying the number of microsystem array sensors for each of the combing nodes based on the amount of communication data, the cost of the combining nodes and the processing capabilities of the combining nodes, as well as other considerations based on the particular application. The network topology may be adjusted based on the physical distribution of microsystem array sensors, the ease of routing the wires, and the performance requirements of the communication system, as well as other considerations based on the particular application. As such, a hierarchical approach may be used in any system having a large number of microsystem array sensors, and the implementation may depend upon several competing concerns, such as, for example, fault tolerance, cost, performance, and physical lay-out.

What is claimed is:

1. An imaging system comprising:
at least one microsystem array, the at least one microsystem array composed of a wide bandgap semiconductor and being in a pixel arrangement; and
an electronic readout arrangement integrated with the at least one microsystem array.

2. The imaging system of claim 1, wherein the wide bandgap semiconductor includes one of a metal and an electrically conductive material.

3. The imaging system of claim 1, wherein the wide bandgap semiconductor includes aluminum nitride.

4. The imaging system of claim 1, wherein the wide bandgap semiconductor includes silicon carbide.

5. The imaging system of claim 1, wherein the at least one microsystem array includes a high density pixel arrangement.

6. The imaging system of claim 5, wherein the at least one microsystem array has at least 2500 pixels per square centimeter.

7. The imaging system of claim 1, further comprising a scintillating layer associated with the at least one microsystem array.

8. The imaging system of claim 7, wherein the scintillating layer is composed of quartz crystals.

9. The imaging system of claim 7, wherein the scintillating layer is composed of cadmium/zinc/telluride (CZT) crystals.

10. The imaging system of claim 1, further comprising a processor arrangement coupled to the electronic readout arrangement.

11. The imaging system of claim 1, wherein the at least one microsystem array is arranged as a module.

12. The imaging system of claim 1, wherein the at least one microsystem array is micro-machined by an Excimer laser.

13. The imaging system of claim 1, wherein the wide bandgap semiconductor is formed by plasma source molecular beam epitaxy.

14. A deposition system for forming a wide bandgap semiconductor, the deposition system comprising:
a plasma source molecular beam epitaxy (PSMBE) deposition source;
a high vacuum chamber; and
a rotating substrate holder enclosed in the high vacuum chamber;
wherein the plasma source molecular beam epitaxy (PSMBE) deposition source is configured to induce crystal growth to form the wide bandgap semiconductor on a substrate positioned on the rotating substrate holder.

15. The deposition system of claim 14, wherein the substrate holder is heated to between 650° C. and 800° C.

16. The deposition system of claim 14, wherein the deposition source includes a magnetically enhanced hollow cathode to induce plasma formation.

17. The deposition system of claim 14, wherein the crystal growth includes polycrystalline crystals.

18. The deposition system of claim 14, wherein the crystal growth includes single crystals.

19. The deposition system of claim 14, wherein the crystal growth includes hexagonal structures.

20. The deposition system of claim 14, wherein the crystal growth includes an initial compliant layer formed at a low temperature.

21. The deposition system of claim 14, wherein the substrate is sapphire.

22. The deposition system of claim 14, wherein the wide bandgap semiconductor is composed of aluminum nitride (AlN).

23. A microsystem array smart sensor, comprising:
a microsystem array sensor arrangement to emit a signal;
an amplifier arrangement to amplify an emitted signal;
a hardware processing arrangement to process an amplified signal;
a data converter to convert a processed signal to provide a converted signal in preparation for transmission; and
a data bus to transmit the converted signal;
wherein the microsystem array sensor arrangement is made using a wide bandgap semiconductor.

24. The microsystem array smart sensor of claim 23, wherein the wide bandgap semiconductor includes aluminum nitride.

25. The microsystem array smart sensor of claim 23, further comprising a data communication arrangement interfaced with the data bus.

26. The microsystem array smart sensor of claim 25, further comprising a software process arrangement interfaced with the data communication arrangement.

27. The microsystem array smart sensor of claim 23, wherein signals of the microsystem array sensor arrangement are communicated to a centralized processor arrangement.

28. A microsystem array smart sensor system, comprising:
a plurality of microsystem array sensor arrangements made using a wide bandgap semiconductor; and
at least one combining node, wherein the plurality of microsystem array sensor arrangements and the at least one combining node are arranged in a hierarchical structure.

29. The microsystem array smart sensor system, wherein the wide bandgap semiconductor includes aluminum nitride.
